(19) United States
(12) Patent Application Publication
(10) Pub. No.: US 2025/0282110 A1
(43) Pub. Date: Sep. 11, 2025

(54) CARBON-FIBER-REINFORCED RESIN CYLINDER FOR PROPELLER SHAFTS

(71) Applicant: Hitachi Astemo, Ltd., Ibaraki (JP)

(72) Inventors: Takahiro NAKAYAMA, Ibaraki (JP); Daejin SHIN, Ibaraki (JP)

(21) Appl. No.: 18/859,470

(22) PCT Filed: Jun. 8, 2022
(86) PCT No.: PCT/JP2022/023191

§ 371 Date: Oct. 23, 2024

(51) Int. Cl. B29C 70/86; B29C 70/20; B29K 105/10; B29K 307/04; B29L 31/08

(52) U.S. Cl. CPC B29C 70/86; B29C 70/202; B29K 2105/108; B29K 2307/04; B29K 2995/005; B29L 2031/087

(57) ABSTRACT

A carbon-fiber-reinforced resin cylinder for propeller shafts includes a first-carbon-fiber-reinforced resin layer having a first carbon fiber, and a second-carbon-fiber-reinforced resin layer having a second carbon fiber and being higher in strength and lower in elastic modulus than the first-carbon-fiber-reinforced resin layer. The first carbon fiber is arranged so as to extend along a longitudinal direction of the cylinder.

### CROSS-REFERENCE TO RELATED APPLICATION

This application is a U.S. National Stage Application under 35 U.S.C § 371 of International Patent Application No. PCT/JP2022/023191 filed on 8 Jun. 2022, the disclosure of which is hereby incorporated by reference in its entirety.

### TECHNICAL FIELD

The present invention relates to a carbon-fiber-reinforced resin cylinder for propeller shafts to be used as power transmission shafts in vehicles and the like, for example.

### BACKGROUND ART

Propeller shafts typically used for automobiles are divided into two parts in the front-rear direction and include an intermediate bearing around the center in the front-rear direction. For such propeller shafts, a configuration has been known in which the two-part structure is changed to a single-part structure to improve the energy efficiency and the intermediate bearing is omitted to achieve a weight reduction. In this case, in order to shift the primary bending resonance point of the propeller shaft to a higher frequency, it is necessary to increase the diameter of its cylinder (steel tube).

Propeller shafts transmit large forces and also rotate at high speeds, and therefore require high torsional strength and bending rigidity. As for the bending rigidity in particular, increasing the diameter of a propeller shaft can increase its bending rigidity. However, increasing the diameter of a propeller shaft made of steel makes its mass large. Thus, a technique has been publicly known in which a propeller shaft is made from a carbon-fiber-reinforced resin to reduce the weight increase (see Patent Literature 1, for example).

Shaft members made of a carbon-fiber-reinforced resin are formed by shaping using a filament winding (FW) method. In this method, carbon fibers impregnated with a resin are individually wound around a core member and heated to shape the shaft member. In the case of a shaft member made of a carbon-fiber-reinforced resin, it is effective to wind carbon fibers at an angle to a rotation shaft in order to enhance the torsional strength. Also, it is publicly known to use high modulus carbon fibers in order to enhance the bending rigidity (see Patent Literature 2, for example).

### CITATION LIST

### Patent Literature

Patent Literature 1: JP2001-153126A
Patent Literature 2: JP S61-487A

### SUMMARY OF INVENTION

### Technical Problem

As for the high modulus carbon fibers, there are ones made from a polyacrylonitrile material, known as PAN-based carbon fiber. However, these come with a problem of high costs. Also, it is effective to arrange carbon fibers in parallel to the rotation shaft to enhance the bending rigidity, but doing so requires arranging the carbon fibers minutely along the circumferential direction, which cannot be implemented with the filament winding method.

Incidentally, a sheet winding method has been known in which a pre-preg being a sheet-shaped intermediate material obtained by impregnating carbon fibers with a matrix resin is placed on a core. With this method, bending rigidity can be enhanced by placing and shaping the pre-preg on the core such that the carbon fibers are oriented in the direction of the rotation shaft. However, the material is costly, and the productivity is not high since layers of the sheet are laid one over another to shape the pre-preg. Thus, for products such as propeller shafts, the method is limited only to those for racing.

The present invention has been made in view of such circumstances, and an object thereof is to provide a carbon-fiber-reinforced resin cylinder for propeller shafts that can achieve high bending rigidity and high torsional strength without an increase in cost.

### Solution to Problem

The present disclosure provides a carbon-fiber-reinforced resin cylinder for propeller shafts comprising: a first-carbon-fiber-reinforced resin layer having a first carbon fiber; and a second-carbon-fiber-reinforced resin layer having a second carbon fiber and being higher in strength and lower in elastic modulus than the first-carbon-fiber-reinforced resin layer, wherein the first carbon fiber is arranged so as to extend along a longitudinal direction of the cylinder.

### Advantageous Effects of Invention

According to the present invention, it is possible to provide a carbon-fiber-reinforced resin cylinder for propeller shafts that can achieve high bending rigidity and high torsional strength without an increase in cost.

### BRIEF DESCRIPTION OF DRAWINGS

FIG. 1 is a cross-sectional view schematically showing a mandrel according to a first embodiment of the present invention.

FIG. 2 is a view schematically showing a power transmission shaft manufactured using the mandrel according to the first embodiment of the present invention.

FIG. 3 is a cross-sectional view schematically showing a power transmission shaft according to the first embodiment of the present invention.

FIG. 4 is a schematic view for describing a method of manufacturing the power transmission shaft according to the first embodiment of the present invention, and is a view schematically showing a first carbon fiber layer.

FIG. 5 is a schematic view for describing the method of manufacturing the power transmission shaft according to the first embodiment of the present invention, and is a view schematically showing a second carbon fiber layer.

FIG. 6 is a schematic view for describing the method of manufacturing the power transmission shaft according to the first embodiment of the present invention, and is a view schematically showing a third carbon fiber layer.

FIG. 7 is a flowchart for describing the method of manufacturing the power transmission shaft according to the first embodiment of the present invention.

FIG. 8 is a schematic view for describing the method of manufacturing the power transmission shaft according to the first embodiment of the present invention.

FIG. 9 is a view schematically showing a first carbon fiber layer in a fiber-reinforced resin tube according to a second embodiment of the present invention.

FIG. 10 is a view schematically showing the first carbon fiber layer in the fiber-reinforced resin tube according to the second embodiment of the present invention.

FIG. 11 is a schematic view for describing a method of manufacturing a power transmission shaft according to a third embodiment of the present invention, and is a view schematically showing a first carbon fiber layer.

FIG. 12 is a schematic view for describing the method of manufacturing the power transmission shaft according to the third embodiment of the present invention, and is a view schematically showing a second carbon fiber layer.

FIG. 13 is a schematic view for describing the method of manufacturing the power transmission shaft according to the third embodiment of the present invention, and is a view schematically showing a fourth carbon fiber layer.

FIG. 14 is a schematic view for describing the method of manufacturing the power transmission shaft according to the third embodiment of the present invention, and is a view schematically showing a third carbon fiber layer.

FIG. 15 is a flowchart for describing the method of manufacturing the power transmission shaft according to the third embodiment of the present invention.

### DESCRIPTION OF EMBODIMENTS

Embodiments of the present invention will be described in detail with reference to the drawings by taking, as an example, a case of manufacturing a power transmission shaft (propeller shaft) of a vehicle being an example a fiber-reinforced resin tube from a carbon fiber-reinforced plastic. In the following description, the same elements are denoted by the same reference signs, and overlapping description is omitted. Also, drawings to be referred to are simplified and exaggerated for clarity.

### <<First Embodiment>>

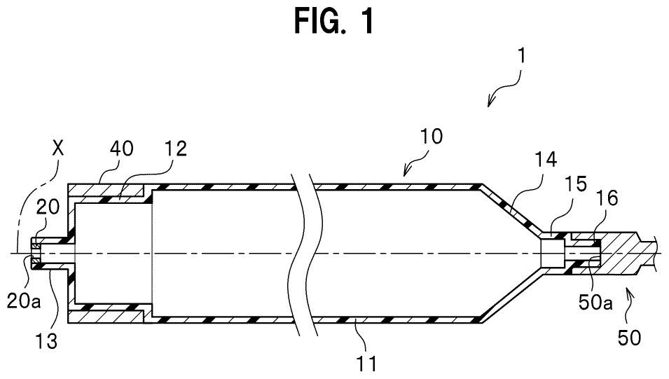

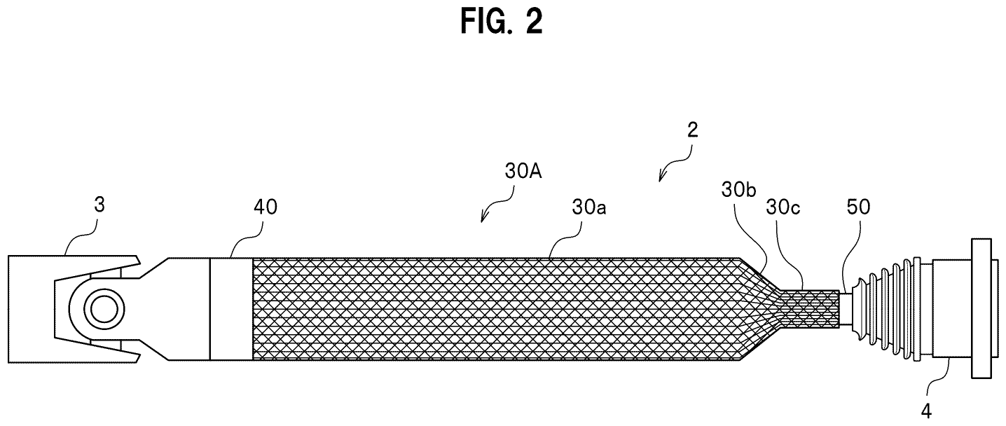

As shown in FIG. 1, a mandrel 1 according to the first embodiment is to be used to manufacture a fiber-reinforced resin tube 30A (see FIG. 2), and includes a mandrel body 10 and an internally fitted member 20.

### <<Mandrel Body>>

The mandrel body 10 is a resin member assuming a tubular shape. In the present embodiment, the mandrel body 10 is removed from inside the fiber-reinforced resin tube 30A, but can remain inside the fiber-reinforced resin tube 30A to function as a core member for the fiber-reinforced resin tube 30A. For the mandrel body 10, a material capable of withstanding heating for curing the resin in the fiber-reinforced resin tube 30A can be used. Examples of such a material include PP (polypropylene resin), PET (polyethylene terephthalate resin), SMP (shape memory polymer), and so on. The mandrel body 10 integrally includes: a large diameter portion 11 at a middle portion in the axial direction; a stepped portion 12 and a small diameter portion 13 formed at an end portion on one side in the axial direction; and a tapered portion 14 and a small diameter portion 15 formed at an end portion on the other side in the axial direction. In the present embodiment, a protruding portion 16 smaller in diameter than the small diameter portion 15 is formed at the end of the small diameter portion 15 on the other side in the axial direction. The protruding portion 16 is a portion on which to fit a second metallic member 50. Note that the mandrel body 10 may be a metallic member. Also, the mandrel body 10 as a metallic member may be configured to be pulled out of the fiber-reinforced resin tube 30A after shaping of the fiber-reinforced resin tube 30A.

### <<Internally Fitted Member>>

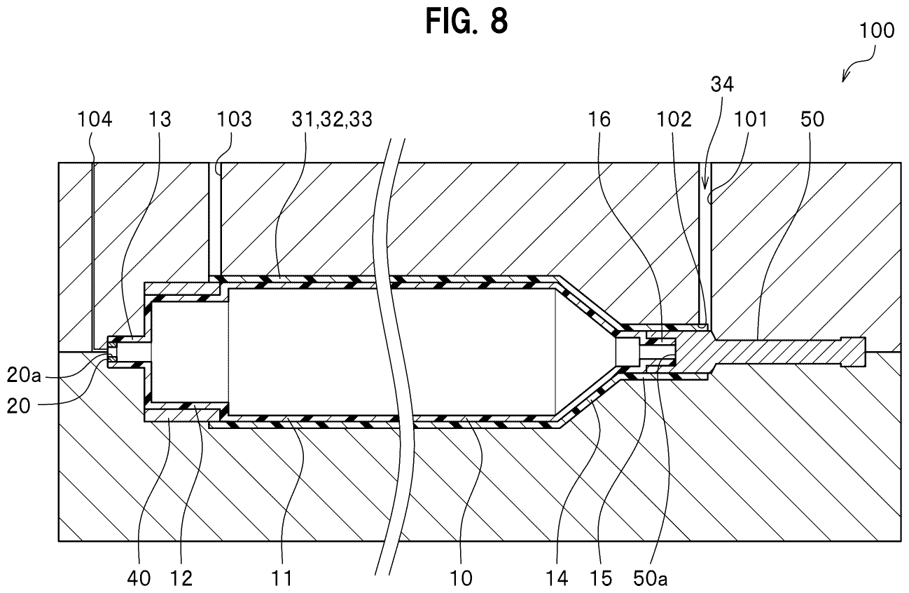

The internally fitted member 20 is a tubular metallic member to be fitted into the small diameter portion 13, which is an end portion of the mandrel body 10 on the one side in the axial direction. The internally fitted member 20 is intended to prevent radially inward deformation of the small diameter portion 13, and a channel 20a for filling a pressurization fluid F (see FIG. 8) (e.g., pressurized air) into the mandrel body 10 is formed. In the present embodiment, the pressurization fluid F is intended to pressurize the inside of the mandrel body 10 to expand it inside a shaping apparatus 100. The pressurization fluid F is also a heating fluid for heating a thermosetting resin (a resin 34 to be described later) placed on the outer peripheral surface of the mandrel body 10 inside the shaping apparatus 100 to be described later. Note that if the mandrel body 10 is a metallic member, the internally fitted member 20 can be omitted by integrating it with the mandrel body 10.

### <Power Transmission Shaft>

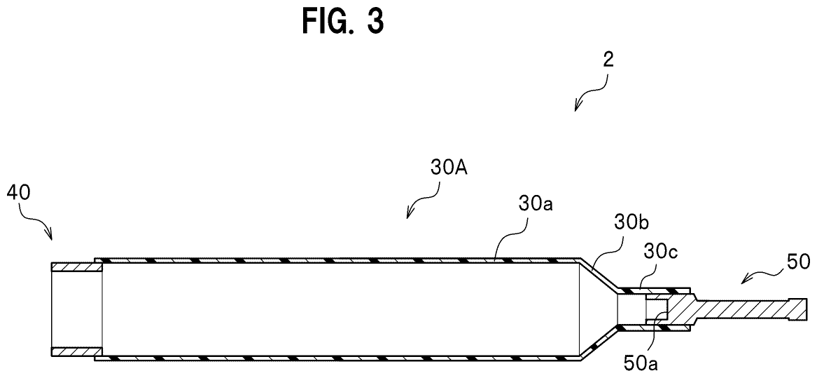

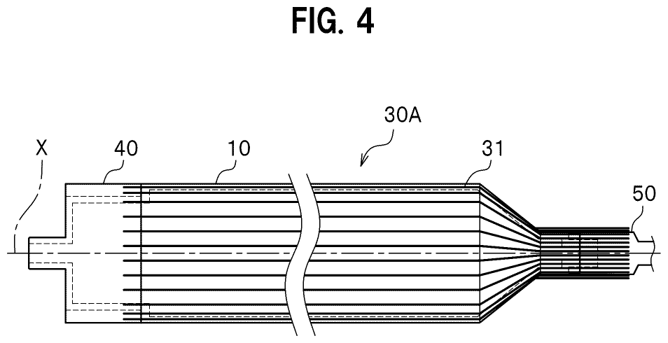

As shown in FIGS. 2 and 3, a power transmission shaft 2 manufactured using the mandrel 1 (see FIG. 1) is a shaft that is provided in a vehicle so as to extend in its front-rear direction, and transmits power generated by a power source in the form of rotations about the axis. The power transmission shaft 2 includes the fiber-reinforced resin tube 30A, a first metallic member 40, the second metallic member 50, and universal joints 3 and 4. The fiber-reinforced resin tube 30A is a carbon-fiber-reinforced resin cylinder for propeller shafts that transmit a propulsive force by rotating about the axis of the fiber-reinforced resin tube 30A.

<Fiber-Reinforced Resin Tube>The fiber-reinforced resin tube 30A is a resin-containing fiber layer formed into a tubular shape along the outer peripheral surface of the mandrel body 10. The fiber-reinforced resin tube 30A is formed along the outer peripheral surfaces of the large diameter portion 11, the tapered portion 14, and the small diameter portion 15 of the mandrel body 10 and the outer peripheral surfaces of an end portion of the first metallic member 40 on the other side in the axial direction and an end portion of the second metallic member 50 on the one side in the axial direction. As shown in FIGS. 4 to 6, the fiber-reinforced resin tube 30A includes a first carbon fiber layer 31, a second carbon fiber layer 32, and a third carbon fiber layer 33 in this order from the inner side in the radial direction (mandrel body 10 side) as carbon fiber layers. The carbon fibers forming the second carbon fiber layer 32 and the third carbon fiber layer 33 (second carbon fibers) are higher in strength and lower in elastic modulus than the carbon fibers forming the first carbon fiber layer 31 (first carbon fibers). Incidentally, the carbon fiber layers 31, 32, and 33 are shown only partly in FIGS. 4 to 6. Also, the outer peripheral surface of an end portion of the first metallic member 40 on the one side in the axial direction (an end portion located opposite from the mandrel body 10) and the outer peripheral surface of an end portion of the second metallic member 50 on the other side in the axial direction (an end portion located opposite from the mandrel body 10) are not covered with the fiber-reinforced resin tube 30A and project from the fiber-reinforced resin tube 30A.

### <<First Carbon Fiber Layer>>

As shown in FIG. 4, the first carbon fiber layer 31 is formed of a plurality of carbon fibers provided over the outer peripheral surfaces of the mandrel body 10 and the like so as to cover the mandrel body 10. More specifically, a plurality of carbon fibers are gathered into the shape of a strip or a bundle to form a carbon fiber aggregate, and a plurality of carbon fiber aggregates are provided at different phases to form the first carbon fiber layer 31. The carbon fibers in the first carbon fiber layer 31 are provided so as to extend in parallel to the axial direction of the mandrel body 10. That is, the orientation angle of the carbon fibers in the first carbon fiber layer 31 with respect to an axis X of the mandrel body 10 is 0°.

The carbon fibers in the first carbon fiber layer 31 (first carbon fibers) are pitch-based carbon fibers. The first carbon fiber layer 31 is impregnated with the resin 34, which then cures to form a single first-carbon-fiber-reinforced resin layer. The first-carbon-fiber-reinforced resin layer formed of the first carbon fiber layer 31 and the resin 34 is a straight reinforcement layer in which the first carbon fibers are arranged in parallel to the longitudinal direction of the cylinder (fiber-reinforced resin tube 30A). The first carbon fiber layer 31 (and a fourth carbon fiber layer 35 to be described later) contributes to the eigenvalue (eigenfrequency) and bending rigidity of the fiber-reinforced resin tube 30A.

In the first carbon fiber layer 31 (and the fourth carbon fiber layer 35 to be described later), the plurality of first carbon fibers are arranged at equal intervals in the circumferential direction. The interval between adjacent first carbon fibers can be set as appropriate. Setting a small interval between first carbon fibers adjacent to each other in the circumferential direction can increase the number of first carbon fibers in the fiber-reinforced resin tube 30A and improve the bending rigidity of the fiber-reinforced resin tube 30A. Also, setting a large interval between first carbon fibers adjacent to each other in the circumferential direction can decrease the number of first carbon fibers in the fiber-reinforced resin tube 30A and reduce the cost of the fiber-reinforced resin tube 30A.

### <<Second Carbon Fiber Layer>>

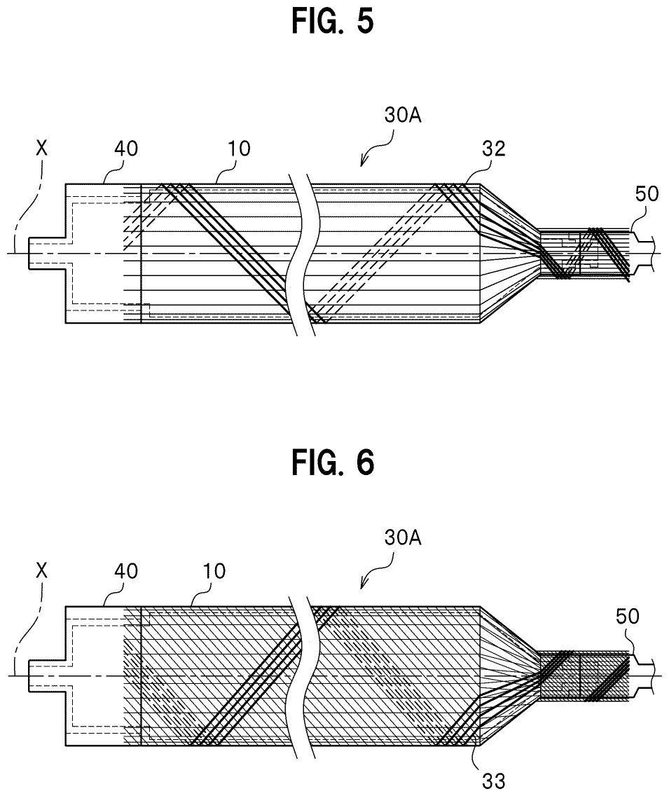

As shown in FIG. 5, the second carbon fiber layer 32 is provided on the radially outer side of the first carbon fiber layer 31 and formed of a plurality of carbon fibers provided so as to cover the first carbon fiber layer 31. More specifically, a plurality of carbon fibers are gathered into the shape of a strip or a bundle to form a carbon fiber aggregate, and a plurality of carbon fiber aggregates are provided at different phases to form the second carbon fiber layer 32. The carbon fibers in the second carbon fiber layer 32 are wound around the mandrel body 10 one or more times at an angle of 45° to its axial direction so as to extend helically with respect to the axial direction of the mandrel body 10. That is, the orientation angle of the carbon fibers in the second carbon fiber layer 32 with respect to the axis X of the mandrel body 10 is 45°.

The carbon fibers in the second carbon fiber layer 32 (second carbon fibers) are polyacrylonitrile-based carbon fibers. The second carbon fiber layer 32 is impregnated with the resin 34, which then cures to form a single second-carbon-fiber-reinforced resin layer. The second-carbon-fiber-reinforced resin layer formed of the second carbon fiber layer 32 and the resin 34 is a first bias reinforcement layer in which the second carbon fibers have an orientation angle with respect to the longitudinal direction of the cylinder (fiber-reinforced resin tube 30A). The second carbon fiber layer 32 contributes to the torsional strength of the fiber-reinforced resin tube 30A.

### <<Third Carbon Fiber Layer>>

As shown in FIG. 6, the third carbon fiber layer 33 is provided on the radially outer side of the second carbon fiber layer 32 and formed of a plurality of carbon fibers provided so as to cover the second carbon fiber layer 32. More specifically, a plurality of carbon fibers are gathered into the shape of a strip or a bundle to form a carbon fiber aggregate, and a plurality of carbon fiber aggregates are provided at different phases to form the third carbon fiber layer 33. The carbon fibers in the third carbon fiber layer 33 are wound around the mandrel body 10 one or more times at an angle of −45° to its axial direction so as to extend helically with respect to the axial direction of the mandrel body 10. That is, the orientation angle of the carbon fibers in the third carbon fiber layer 33 with respect to the axis X of the mandrel body 10 is −45°.

The carbon fibers in the third carbon fiber layer 33 (second carbon fibers) are polyacrylonitrile-based carbon fibers. The third carbon fiber layer 33 is impregnated with the resin 34, which then cures to form a single second-carbon-fiber-reinforced resin layer. The second-carbon-fiber-reinforced resin layer formed of the third carbon fiber layer 33 and the resin 34 is a second bias reinforcement layer in which the second carbon fibers have an orientation angle with respect to the longitudinal direction of the cylinder (fiber-reinforced resin tube 30A) in the opposite direction to that in the first bias reinforcement layer. The third carbon fiber layer 33 contributes to the torsional strength of the fiber-reinforced resin tube 30A.

The first carbon fibers in the first carbon fiber layer 31 (and the fourth carbon fiber layer 35 to be described later) are lower in strength and higher in elastic modulus than the second carbon fibers, and it is desirable that the tensile elastic modulus be set to 420 GPa or more and the tensile strength be set to 2600 MPa or more, for example. The second carbon fibers in the second carbon fiber layer 32 and the third carbon fiber layer 33 are higher in strength and lower in elastic modulus than the first carbon fibers and it is desirable that the tensile strength be set to 3500 to 7000 MPa and the tensile elastic modulus be set to 230 to 324 GPa, for example.

As shown in FIGS. 2 and 3, at an end portion of the fiber-reinforced resin tube 30A on the other side in the axial direction, a tapered portion 30b is formed which decreases in diameter from a large diameter portion 30a on the center side in the axial direction toward a small diameter portion 30c at the end portion on the other side in the axial direction. The large diameter portion 30a is a body portion assuming a shape conforming with the outer peripheral surface of the large diameter portion 11 of the mandrel body 10. The tapered portion 30b assumes a shape conforming with the outer peripheral surface of the tapered portion 14 of the mandrel body 10. The small diameter portion 30c is an end portion assuming a shape conforming with the outer peripheral surfaces of the small diameter portion 15 of the mandrel body 10 and part of the second metallic member 50.

### <First Metallic Member>

The first metallic member 40 is a member substantially assuming the shape of a hollow cylinder. As shown in FIG. 5 and other drawings, the first metallic member 40 is fitted to (fitted on) the mandrel body 10 at a given point during the manufacture.

The first metallic member 40 is one member of the universal joint (yoke assembly) 3 of the power transmission shaft 2. The universal joint 3 is formed by assembling a spider, a needle bearing, and a yoke body to the first metallic member 40.

### <Second Metallic Member>

The second metallic member 50 is a member substantially assuming the shape of a solid cylinder (shaft). As shown in FIG. 5 and other drawings, the second metallic member 50 is fitted to (fitted on) the mandrel body 10 at a given point during the manufacture.

As shown in FIG. 1, a hole portion 50a with a closed bottom into which the protruding portion 16 of the mandrel body 10 is insertable is formed in the end portion of the second metallic member 50 on the one side in the axial direction.

The second metallic member 50 is one member of the universal joint 4 (plunge joint assembly) of the power transmission shaft 2. The universal joint 4 is formed by assembling a boot and a plunge joint body to the second metallic member 50.

### <Manufacturing Method>

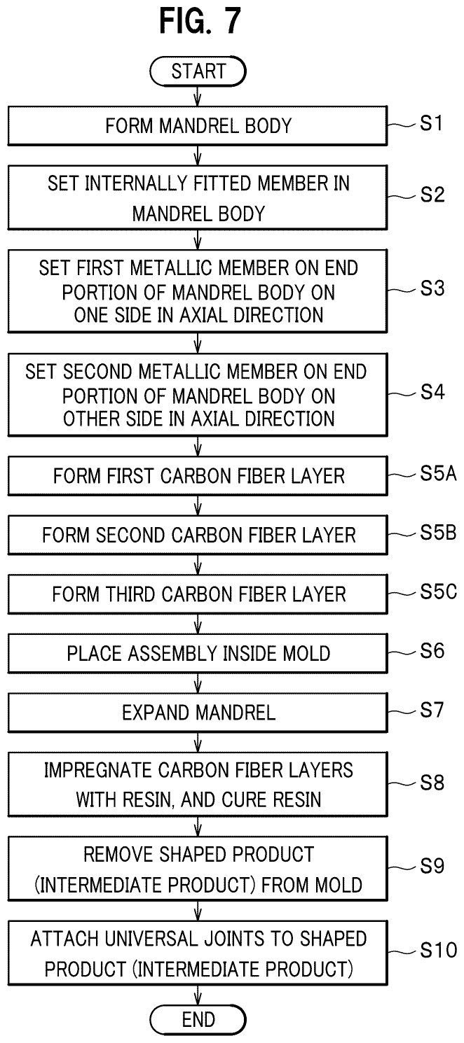

Next, a method of manufacturing the power transmission shaft 2 using the mandrel 1 according to the first embodiment of the present invention will be described using the flowchart of FIG. 7. The method of manufacturing the power transmission shaft 2 includes a mandrel body forming step (step S1), an internally fitted member placement step (step S2) to be executed after the mandrel body forming step, a first coupling step (step S3) to be executed after the internally fitted member placement step, and a second coupling step (step S4) to be executed after the first coupling step. The method of manufacturing the power transmission shaft 2 also includes a fiber setting step (steps S5A to S5C) to be executed after the second coupling step, and a mold loading step (step S6) to be executed after the fiber setting step. The method of manufacturing the power transmission shaft 2 also includes an expansion step (step S7) to be executed after the mold loading step, and a molding step (step S8) to be executed after the expansion step. The method of manufacturing the power transmission shaft 2 also includes a removal step (step S9) to be executed after the molding step, and a joint assembling step (step S10) to be executed after the removal step.

Step S1 is a step of forming the resin mandrel body 10 shown in FIG. 1 with a shaping apparatus not shown.

After step S1 is step S2, in which the internally fitted member 20 is press-fitted into the small diameter portion 13 of the mandrel body 10. In the press-fitting, a lubricant may be applied between the outer peripheral surface of the internally fitted member 20 and the inner peripheral surface of the small diameter portion 13. Note that step S2 only needs to be executed before step S8.

After step S2 is step S3, in which the first metallic member 40 is set on the end portion of the mandrel body 10 on the one side in the axial direction. In step S3, the first metallic member 40 is fitted to (fitted on) the stepped portion 12 of the mandrel body 10.

After step S3 is step S4, in which the second metallic member 50 is set on the end portion of the mandrel body 10 on the other side in the axial direction. In step S4, the second metallic member 50 is fitted to (fitted into) the protruding portion 16 of the mandrel body 10. Here, the order of steps S3 and S4 can be changed as appropriate. Step S4 may be executed first or executed at the same time.

After step S4 is step S5A, in which the first carbon fiber layer 31 is formed on the outer peripheral surfaces of the mandrel body 10, the first metallic member 40, and the second metallic member 50, as shown in FIG. 4. After step S5A is step S5B, in which the second carbon fiber layer 32 is formed on the outer peripheral surface of the first carbon fiber layer 31 on the mandrel body 10, the first metallic member 40, and the second metallic member 50, as shown in FIG. 5. After step S5B is step S5C, in which the third carbon fiber layer 33 is formed on the outer peripheral surface of the second carbon fiber layer 32 on the mandrel body 10, the first metallic member 40, and the second metallic member 50, as shown in FIG. 6. In steps S5A to S5C, the carbon fiber layers 31 to 33 are formed such that their fibers are not arranged on end portions of the first metallic member 40 and the second metallic member 50 located opposite from the mandrel 10 in the axial direction.

In steps S5A to S5C, the carbon fiber layers 31 to 33 are not fibers impregnated with a resin but are so-called raw fibers. Also, the carbon fiber layers 31 to 33 are arranged in a concurrent fashion on the outer peripheral surfaces of the end portions of the mandrel body 10, the first metallic member 40, and the second metallic member 50 on the other side in the axial direction by a multi-filament winding method. The carbon fiber layers 31 to 33 formed of fibers fed by the multi-filament winding method assume a so-called non-crimp structure in which they are not interwoven but formed as independent layers.

In steps S5A to S5C, the carbon fiber layers 31 to 33 are arranged on the outer peripheral surfaces of the mandrel body 10 and the like by an apparatus not shown. This apparatus is capable of setting and changing the orientation angles of the carbon fiber layers 31 to 33 as appropriate. Incidentally, the configuration may be such that the carbon fiber layers 31 to 33 are arranged on the outer peripheral surfaces of the mandrel body 10 and the like after being arranged into an integrated tubular form by the apparatus.

In a (single-)filament winding method, jigs having a plurality of radially extending pins are arranged at both end portions of a mandrel, and a single carbon fiber locked to a pin is repetitively wound around the outer peripheral surface of the mandrel to form a fiber layer. Thus, in the (single-)filament winding method, the carbon fiber layer 31, which needs to be arranged on the mandrel body 10 and the like without being wound therearound even once, may not be held in a favorable manner on the outer peripheral surfaces of the mandrel body 10 and the like.

In contrast, in the multi-filament winding method, for each of the carbon fiber layers 31 to 33, a plurality of carbon fibers are arranged so as to form a tubular layer and, in this state, the mandrel body 10 and the like are inserted into the tubular layer (or the tubular layer is fitted onto the mandrel body 10 and the like). Also, the multi-filament winding method can form the carbon fiber layers 31 to 33 in a concurrent fashion. Thus, with the multi-filament winding method, the carbon fiber layer 31, which needs to be arranged on the mandrel body 10 and the like without being wound therearound even once, can be held on the outer peripheral surfaces of the mandrel body 10 and the like in a favorable manner by the carbon fiber layers 32 and 33 on the radially outer side.

After step S5C is step S6, in which the assembly of the mandrel 1, the first metallic member 40, the second metallic member 50, and the carbon fiber layers 31 to 33 is placed inside a shaping apparatus (mold) 100, as shown in FIG. 8.

After step S6 is step S7, in which the mandrel body 10 is expanded. As shown in FIG. 8, in the shaping apparatus 100 in the first embodiment, a communication channel 104 is provided so as to communicate with the inside of the mandrel body 10 through the channel 20a. In step S7, the pressurization fluid F (e.g., pressurized air at 140° C. or higher) is filled into the hollow portion of the mandrel body 10 through the communication channel 104, which is coupled to a supply apparatus not shown. The mandrel body 10 heated by the hot pressurization fluid F softens as it reaches a lower temperature (80° C., which is the transformation temperature) lower than the temperature at which the resin 34 cures, and is pressurized from inside by the pressurization fluid F to thereby undergo such an expanding deformation as to conform with the inner peripheral surface of the shaping apparatus 100. The pressurization can prevent the mandrel body 10 from being deformed in such a direction as to become radially shrink by the resin 34 filled therearound. The pressurization can also reduce the amount of the resin 34 to be filled and thus prevent an increase in the weight of the fiber-reinforced resin tube 30A as a finished product.

After step S7, the resin 34 is filled into the shaping apparatus 100. As a result, the carbon fiber layers 31 to 33 arranged on the outer peripheral surface of the mandrel body 10 are impregnated with the resin 34. Further, the shaping apparatus 100 is heated to cure the resin 34, so that the fiber-reinforced resin tube 30A is formed and also the fiber-reinforced resin tube 30A is molded integrally with the first metallic member 40 and the second metallic member 50 (step S8: molding step). The resin 44 is a thermosetting resin, for example. In the present embodiment, the mold of the shaping apparatus 100 is separated into a plurality of parts. In step S9, while the assembly is heated, a mold closing operation of closing the mold of the shaping apparatus 100 is also performed, and then a mold clamping operation of applying a pressure to the closed mold is performed to raise the pressure inside the mold, thereby promoting the curing of the resin 34. Note that the mold closing operation and the mold clamping operation are performed since the present embodiment is described based on the configuration in which the mold is formed of a plurality of separated parts, but the mold clamping operation is not essential. Also, the mold closing operation and the mold clamping operation are not essential if the mold is not formed of a plurality of separated parts. Inside the shaping apparatus 100, a space (resin pocket 102) is formed around the outlet of a gate 101 into which the molten resin 34 is introduced. The resin 34 introduced into the shaping apparatus 100 is stored in the resin pocket 102 located on a lateral side of end portions of the carbon fiber layers 31 to 33 on the other side in the axial direction. The resin 34 stored in the resin pocket 102 is moved in the axial direction of the mandrel body 10 by vacuum suction performed from a suction port 103 formed on the opposite side from the gate 101 in the direction of arrangement of the carbon fiber layers 31 to 33 (around the outer peripheral surfaces of end portions of the carbon fiber layers 31 to 33 on the one side in the axial direction), so that the carbon fiber layers 31 to 33 are impregnated with the resin 34. The shaping apparatus 100 is heated and also a pressure is applied to the inside of the shaping apparatus 100 in the state where the carbon fiber layers 31 to 33 are impregnated with the resin 34. As a result, the fiber-reinforced resin tube 30A is formed.

After step S8 is step S9, in which the molded assembly, i.e., an intermediate product, is removed from the shaping apparatus 100. After step S9 is step S10, in which the universal joint 3 is attached to the intermediate product's first metallic member 40, and the universal joint 4 is attached to the second metallic member 50.

Incidentally, a mandrel removal step may be executed between steps S9 and S10. This mandrel removal step is a step of removing the mandrel 1 out of the fiber-reinforced resin tube 30A from the side of the first metallic member 40 with its end opening. At this time, the mandrel 1 is, for example, deformed, melted, decomposed, destructed, or eluted by a method suitable for the material used to be removed from the inside of the fiber-reinforced resin tube 30A. This allows for a reduction in the weight of the power transmission shaft 2.

Also, in the case of deforming the mandrel 1 to remove it from the end opening side of the first metallic member 40, it is possible to employ, for example, a method in which the mandrel 1 is shrunk to be smaller than the end opening via depressurization of the hollow portion of the mandrel body 10 and then taken out of the fiber-reinforced resin tube 30A.

When the mandrel removal step is performed, it is possible to depressurize the hollow portion of the mandrel body 10 through the communication channel 104 coupled to a vacuum pump not shown.

Such a mandrel removal step can be performed in a more favorable manner by plasticizing a mandrel body 10 made of a thermoplastic resin by heating or the like, for example. The mandrel removal step can also be performed in a favorable manner with a mandrel body 10 made of a thin aluminum plate with diamond patterns, for example.

The fiber-reinforced resin tube 30A according to the first embodiment of the present invention includes the first-carbon-fiber-reinforced resin layer, which has the first carbon fibers, and the second-carbon-fiber-reinforced resin layer, which has the second carbon fibers and is higher in strength and lower in elastic modulus than the first-carbon-fiber-reinforced resin layer, and the first carbon fibers are arranged so as to extend along the longitudinal direction of the cylinder.

Thus, in the fiber-reinforced resin tube 30A, the first carbon fibers, which have a relatively high elastic modulus, are provided so as to extend along the longitudinal direction of the cylinder. Accordingly, the second carbon fibers, which have a relatively low elastic modulus, can be the carbon fibers in the other layers. This makes it possible to ensure high bending rigidity and high torsional rigidity without causing an increase in cost.

The fiber-reinforced resin tube 30A includes a carbon-fiber-reinforced resin layer having at least one layer of pitch-based carbon fibers as the first-carbon-fiber-reinforced resin layer, and a carbon-fiber-reinforced resin layer having at least two layers of polyacrylonitrile-based carbon fiber as the second-carbon-fiber-reinforced resin layer.

Thus, in the fiber-reinforced resin tube 30A, the PAN-based fibers as the second carbon fibers do not need to have a high elastic modulus. This makes it possible to ensure high bending rigidity and high torsional rigidity and achieve a cost reduction in a favorable manner.

In the fiber-reinforced resin tube 30A, the second-carbon-fiber-reinforced resin layer is provided on the radially outer side of the first-carbon-fiber-reinforced resin layer.

Thus, the second carbon fibers firmly hold the first carbon fibers from the radially outer side during the manufacture. This can improve the manufacturability of the fiber-reinforced resin tube 30A. Also, in the fiber-reinforced resin tube 30A, the first-carbon-fiber-reinforced resin layer is provided radially inward of the second-carbon-fiber-reinforced resin layer. This makes it possible to ensure high bending rigidity with a small cross-sectional area (less fibers), that is, at a low cost.

In the fiber-reinforced resin tube 30A, the first-carbon-fiber-reinforced resin layer is laid by a multi-filament winding method.

Thus, during the manufacture of the fiber-reinforced resin tube 30A, the first carbon fibers and the second carbon fibers are each such that the plurality of carbon fibers, which are to be arranged side by side in the circumferential direction, can be arranged in a single step, and the first carbon fibers can be arranged in a concurrent fashion with the second carbon fibers. This can improve the manufacturability.

Also, the second-carbon-fiber-reinforced resin layer includes the first bias reinforcement layer, in which the second carbon fibers have an orientation angle with respect to the longitudinal direction of the cylinder, and the second bias reinforcement layer, which is provided on the radially outer side of the first bias reinforcement layer and in which the second carbon fibers have an orientation angle with respect to the longitudinal direction of the cylinder in the opposite direction to that in the first bias reinforcement layer, and the first-carbon-fiber-reinforced resin layer is a straight reinforcement layer in which the first carbon fibers are arranged in parallel to the longitudinal direction of the cylinder.

Thus, it is possible to ensure high bending rigidity with the straight reinforcement layer and ensure torsional strength in two directions with the two bias reinforcement layers.

In the fiber-reinforced resin tube 30A, the first carbon fibers are arranged at equal intervals in the circumferential direction.

Thus, the fiber-reinforced resin tube 30A can achieve uniform bending rigidity in the circumferential direction.

### <Second Embodiment>

Next, a fiber-reinforced resin tube according to a second embodiment of the present invention will be described focusing mainly on the difference from the fiber-reinforced resin tube 30A according to the first embodiment.

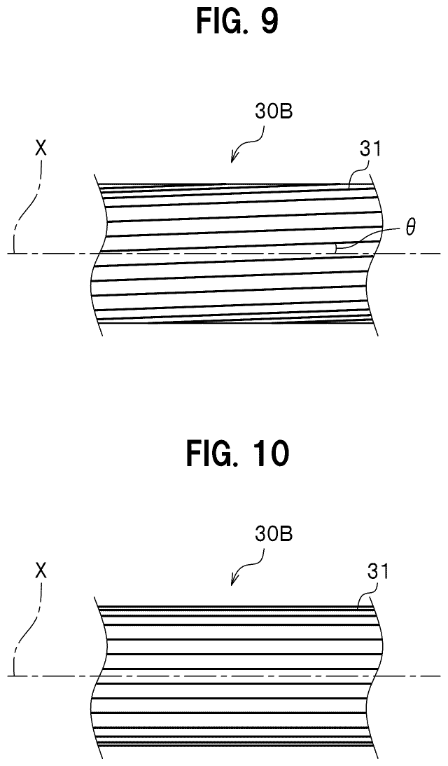

As shown in FIG. 9, in a fiber-reinforced resin tube 30B according to the second embodiment of the present invention, the first carbon fibers in the first carbon fiber layer 31 are inclined with respect to the axial direction of the mandrel body 10 (angle θ). The inclination angle of the first carbon fibers in the first carbon fiber layer 31 is set such that a twisting torque exerted on the cylinder (fiber-reinforced resin tube 30B) when the cylinder is subjected to the maximum rotational speed (e.g., the maximum rotational speed of the power transmission shaft 2 when a vehicle employing it moves forward) decreases the inclination angle toward a parallel angle to the longitudinal direction of the cylinder. That is, the orientation angle of the carbon fibers in the first carbon fiber layer 31 with respect to the axis X of the mandrel body 10 is preferably 0° (see FIG. 10) in a state where the cylinder is subjected to the maximum rotational speed.

In the fiber-reinforced resin tube 30B according to the second embodiment of the present invention, the second-carbon-fiber-reinforced resin layer includes the first bias reinforcement layer, in which the second carbon fibers have an orientation angle with respect to the longitudinal direction of the cylinder, and the second bias reinforcement layer, which is provided on the radially outer side of the first bias reinforcement layer and in which the second carbon fibers have an orientation angle with respect to the longitudinal direction of the cylinder in the opposite direction to that in the first bias reinforcement layer, and the first carbon fibers in the first-carbon-fiber-reinforced resin layer are arranged so as to be inclined with respect to the longitudinal direction of the cylinder, and the inclination angle of the first-carbon-fiber-reinforced resin layer is set such that a twisting torque exerted on the cylinder when the cylinder is subjected to the maximum rotational speed decreases the inclination angle toward a parallel angle to the longitudinal direction of the cylinder.

In this way, the fiber-reinforced resin tube 30B can achieve desired bending rigidity at the maximum rotational speed and therefore achieve improved endurance reliability.

### <Third Embodiment>

Next, a power transmission shaft according to a third embodiment of the present invention will be described focusing mainly on the differences from the fiber-reinforced resin tubes 30A and 30B according to the first and second embodiments.

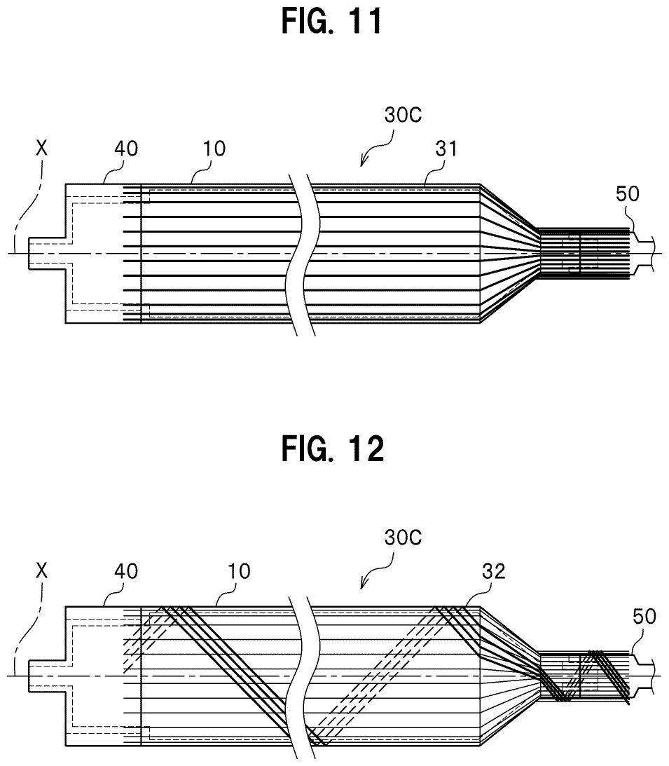

As shown in FIGS. 11 to 14, a fiber-reinforced resin tube 30C according to the third embodiment of the present invention further includes a fourth carbon fiber layer 35 in addition to the first carbon fiber layer 31, the second carbon fiber layer 32, and the third carbon fiber layer 33.

### <<Fourth Carbon Fiber Layer>>

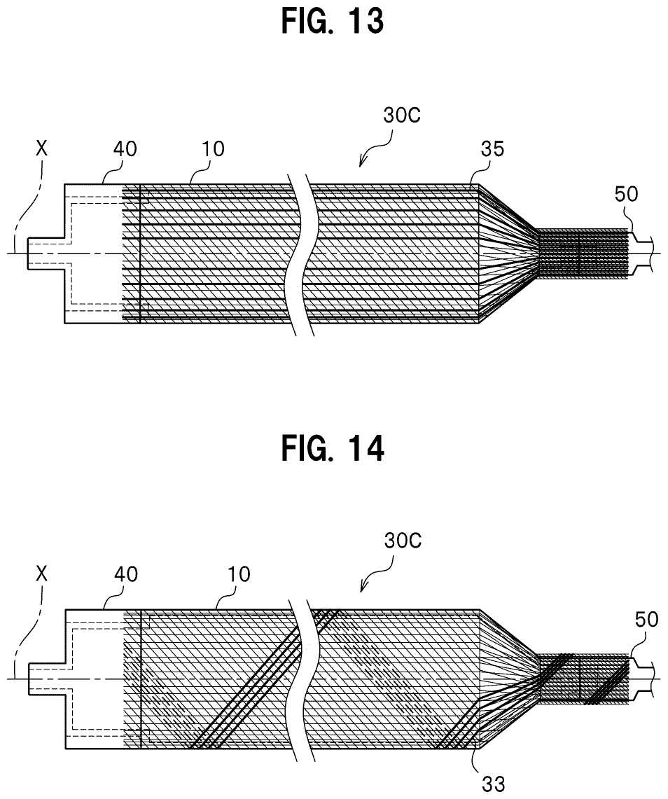

As shown in FIGS. 11 to 14 (FIG. 13 in particular), the fourth carbon fiber layer 35 is provided on the radially outer side of the second carbon fiber layer 32 and radially inner side of the third carbon fiber layer 33, and is formed of a plurality of carbon fibers provided so as to cover the second carbon fiber layer 32. More specifically, a plurality of carbon fibers are gathered into the shape of a strip or a bundle to form a carbon fiber aggregate, and a plurality of carbon fiber aggregates are provided at different phases to form the fourth carbon fiber layer 35. The carbon fibers in the fourth carbon fiber layer 35 are provided so as to extend in parallel to the axial direction of the mandrel body 10. That is, the orientation angle of the carbon fibers in the fourth carbon fiber layer 35 with respect to the axis X of the mandrel body 10 is 0°.

The carbon fibers in the fourth carbon fiber layer 35 (first carbon fibers) are pitch-based carbon fibers. The fourth carbon fiber layer 35 is impregnated with the resin 34 (see FIG. 8), which then cures to form a single first-carbon-fiber-reinforced resin layer. The first-carbon-fiber-reinforced resin layer formed of the fourth carbon fiber layer 35 and the resin 34 is a straight reinforcement layer in which the first carbon fibers are arranged in parallel to the longitudinal direction of the cylinder (fiber-reinforced resin tube 30C). In the fourth carbon fiber layer 35, the plurality of first carbon fibers are arranged at equal intervals in the circumferential direction.

The configuration may be such that the first carbon fibers in the first carbon fiber layer 31 and/or the fourth carbon fiber layer 35 in the fiber-reinforced resin tube 30C are inclined with respect to the axial direction of the mandrel body 10, like the first carbon fibers in the first carbon fiber layer 31 of the fiber-reinforced resin tube 30B according to the second embodiment.

### <Manufacturing Method>

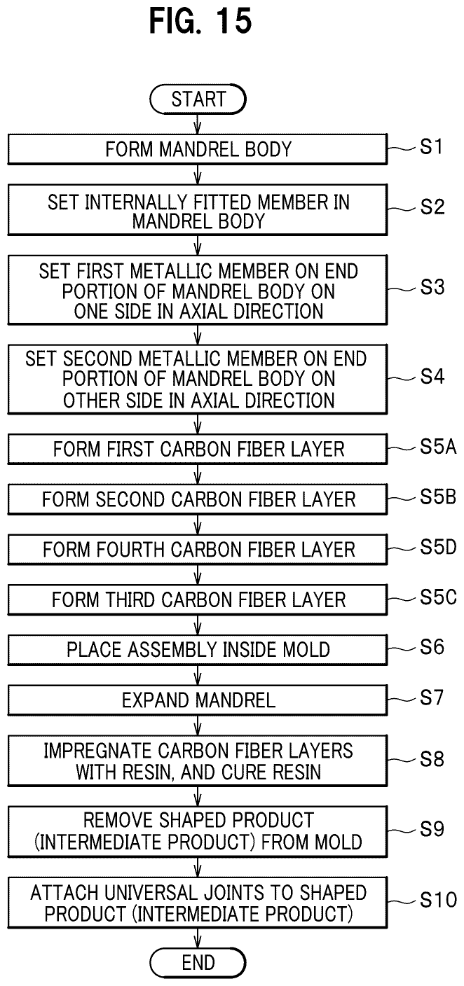

Next, a method of manufacturing the power transmission shaft 2 (fiber-reinforced resin tube 30C) using the mandrel 1 according to the third embodiment of the present invention will be described using the flowchart of FIG. 15.

In this manufacturing method, in step S5A, the first carbon fiber layer 31 is formed on the outer peripheral surfaces of the mandrel body 10, the first metallic member 40, and the second metallic member 50, as shown in FIG. 11. After step S5A is step S5B, in which the second carbon fiber layer 32 is formed on the outer peripheral surface of the first carbon fiber layer 31 on the mandrel body 10, the first metallic member 40, and the second metallic member 50, as shown in FIG. 12. After step S5B is step S5D, in which the fourth carbon fiber layer 35 is formed on the outer peripheral surface of the second carbon fiber layer 32 on the mandrel body 10, the first metallic member 40, and the second metallic member 50, as shown in FIG. 13. After step S5D is step S5C, in which the third carbon fiber layer 33 is formed on the outer peripheral surface of the fourth carbon fiber layer 35 on the mandrel body 10, the first metallic member 40, and the second metallic member 50, as shown in FIG. 14. The fourth carbon fiber layer 35 is arranged in a non-crimp structure in a concurrent fashion with the other carbon fiber layers 31, 32, and 33 by a multi-filament winding method.

In this manufacturing method, in step S8, the first carbon fiber layer 31, the second carbon fiber layer 32, the fourth carbon fiber layer 35, and the third carbon fiber layer 33 are impregnated with the resin 34 (see FIG. 8), which is then caused to cure.

The eigenfrequency (primary bending resonance point) of the fiber-reinforced resin tube 30C according to the third embodiment of the present invention can be set to a different value in a favorable manner without changing the thickness of the fiber-reinforced resin tube 30C, for example, as compared to a case of simply making the first carbon fiber layer 31 thick. Also, the fiber-reinforced resin tube 30C can achieve a desired eigenfrequency by changing the thicknesses of the first carbon fiber layer 31 and the fourth carbon fiber layer 35 as appropriate. Also, the fiber-reinforced resin tube 30C is provided with the fourth carbon fiber layer 35 in addition to the first carbon fiber layer 31, which makes the total thickness of so-called straight layers large. This makes it possible to ensure high bending rigidity in a more favorable manner.

While embodiments of the present invention have been described above, the present invention is not limited to the embodiments, and changes can be made as appropriate without departing from the gist of the present invention. For example, the large diameter portion (body portion) 11 of the mandrel body 10 may expand in a barrel shape which becomes smaller in diameter from a center portion of the large diameter portion 11 toward both ends or expand in a cylindrical shape with the same diameter in the axial direction. Such an expansion shape can be set as appropriate with the shape of the inner peripheral surface of the portion of the shaping apparatus (mold) 100 in which to place the large diameter portion 11. Also, the fluid to be introduced into and filled in the mandrel body 10 may be a fluid for heating the thermosetting resin set on the outer peripheral surface of the mandrel body 10 to cure it in addition to pressurizing the inside of the mandrel body 10. Incidentally, when the fluid is a pressurization fluid not intended for heating, the thermosetting resin will be heated by another heat source.

Also, the configuration may be such that the mandrel 1 is removed from the shaped fiber-reinforced resin tube 30A between steps S9 and S10. Also, the configuration may be such that the mandrel body 10 is removed by melting it with the heat of the resin 44 and the shaping apparatus (mold) 100 in step S8. The mandrel body 10 can be melted by the energies such as the heat, electricity, and vibration of other components and removed. Also, the carbon fiber layers 31 to 33 may be in a so-called crimp structure in which they are interwoven. Also, as a modification, the fibrous bodies are not limited to carbon fibers, and only need to be fibrous members capable of reinforcing resin layers (e.g., glass fibers, cellulose fibers, etc.).

### Reference Signs List

1 mandrel
10 mandrel body
30A, 30B, 30C fiber-reinforced resin tube (carbon-fiber-reinforced resin cylinder for propeller shafts)
31 first carbon fiber layer (first carbon fibers, first-carbon-fiber-reinforced resin layer, straight reinforcement layer)
32 second carbon fiber layer (second carbon fibers, second-carbon-fiber-reinforced resin layer, first bias reinforcement layer)
33 third carbon fiber layer (second carbon fibers, second-carbon-fiber-reinforced resin layer, second bias reinforcement layer)
34 resin
35 fourth carbon fiber layer (first carbon fibers, first-carbon-fiber-reinforced resin layer, straight reinforcement layer)

1. A carbon-fiber-reinforced resin cylinder for propeller shafts comprising:
a first-carbon-fiber-reinforced resin layer having a first carbon fiber; and
a second-carbon-fiber-reinforced resin layer having a second carbon fiber and being higher in strength and lower in elastic modulus than the first-carbon-fiber-reinforced resin layer, wherein
the first carbon fiber is arranged so as to extend along a longitudinal direction of the cylinder, and
the second-carbon-fiber-reinforced resin layer is provided on a radially outer side of the first-carbon-fiber-reinforced resin layer

2. The carbon-fiber-reinforced resin cylinder for propeller shafts according to claim 1, comprising:
a carbon-fiber-reinforced resin layer having at least one layer of a pitch-based carbon fiber as the first-carbon-fiber-reinforced resin layer; and
a carbon-fiber-reinforced resin layer having at least two layers of a polyacrylonitrile-based carbon fiber as the second-carbon-fiber-reinforced resin layer.

3. (canceled)

4. The carbon-fiber-reinforced resin cylinder for propeller shafts according to claim 1, wherein the first-carbon-fiber-reinforced resin layer is laid by a multi-filament winding method.

5. The carbon-fiber-reinforced resin cylinder for propeller shafts according to claim 2, wherein
the second-carbon-fiber-reinforced resin layer includes:
a first bias reinforcement layer in which the second carbon fiber has an orientation angle with respect to the longitudinal direction of the cylinder; and
a second bias reinforcement layer which is provided on a radially outer side of the first bias reinforcement layer and in which the second carbon fiber has an orientation angle with respect to the longitudinal direction of the cylinder in an opposite direction to the orientation angle in the first bias reinforcement layer, and
the first-carbon-fiber-reinforced resin layer is a straight reinforcement layer in which the first carbon fiber is arranged in parallel to the longitudinal direction of the cylinder.

6. The carbon-fiber-reinforced resin cylinder for propeller shafts according to claim 2, wherein
the second-carbon-fiber-reinforced resin layer includes:
a first bias reinforcement layer in which the second carbon fiber has an orientation angle with respect to the longitudinal direction of the cylinder; and
a second bias reinforcement layer which is provided on a radially outer side of the first bias reinforcement layer and in which the second carbon fiber has an orientation angle with respect to the longitudinal direction of the cylinder in an opposite direction to the orientation angle in the first bias reinforcement layer,
the first carbon fiber in the first-carbon-fiber-reinforced resin layer is arranged so as to be inclined with respect to the longitudinal direction of the cylinder, and
an inclination angle of the first-carbon-fiber-reinforced resin layer is set such that a twisting torque exerted on the cylinder when the cylinder is subjected to a maximum rotational speed decreases the inclination angle toward a parallel angle to the longitudinal direction of the cylinder.

7. The carbon-fiber-reinforced resin cylinder for propeller shafts according to claim 1, wherein the first carbon fiber is arranged at equal intervals in a circumferential direction.
